(19) United States
(12) Patent Application Publication
(10) Pub. No.: US 2025/0121282 A1
(43) Pub. Date: Apr. 17, 2025

(54) DISPLAY CONTROL METHOD IN GAME, AND STORAGE MEDIUM AND ELECTRONIC DEVICE THEREOF

(71) Applicant: NETEASE (HANGZHOU) NETWORK CO., LTD., Hangzhou, Zhejiang (CN)

(72) Inventor: Zanchen LI, Hangzhou, Zhejiang (CN)

(73) Assignee: NETEASE (HANGZHOU) NETWORK CO., LTD., Hangzhou, Zhejiang (CN)

(21) Appl. No.: 18/730,333

(22) PCT Filed: Oct. 10, 2022
(86) PCT No.: PCT/CN2022/124322

§ 371 Date: Jul. 19, 2024

(30) Foreign Application Priority Data
May 10, 2022 (CN) 202210505766.X

(51) Int. Cl. A63F 13/424; A63F 13/54; A63F 13/837

(52) U.S. Cl. CPC A63F 13/424; A63F 13/54; A63F 13/837; A63F 2300/6072; A63F 2300/6081; A63F 2300/8076

(57) ABSTRACT

A display control method in a game, a storage medium, and an electronic device. The method includes: acquiring monitoring parameter information of a target virtual character, and acquiring sound parameter information of a first virtual character; calculating based on the monitoring parameter information and the sound parameter information to obtain a sound monitoring result, the sound monitoring result including whether the sound of the first virtual character can be monitored; when the sound of the first virtual character can be monitored, determining a corresponding mapping position on a graphical user interface according to a first position of the first virtual character in a game scenario; and displaying an ideographic graph for representing the first virtual character at the mapping position.

### CROSS REFERENCE TO RELATED APPLICATION

The present disclosure is a U.S. National Stage of International Application No. PCT/CN2022/124322, filed on Oct. 10, 2022, which claims benefit of priority to Chinese Application No. 202210505766.X filed on May 10, 2022 and entitled “DISPLAY CONTROL METHOD AND APPARATUS IN GAME, STORAGE MEDIUM AND ELECTRONIC DEVICE”, both of which are incorporated herein by reference in their entireties for all purpose.

### TECHNICAL FIELD

The present disclosure relates to the field of terminal display technology, and in particular to a display control method and a display control device in a game, a computer-readable storage medium, and an electronic device.

### BACKGROUND

At present, visualizing sounds in games has become an important way to enhance audiovisual experience of players and optimize their gaming experience. In shooting games, the visualization of sounds is mainly to display UI (User Interface) prompts at the top of the screen. By combining with a compass or using a compass-like display logic, a volume bar graph is displayed at the compass position at the top of the screen to mark the direction of the sound, so as to remind players of the direction of the sound. Further, based on the compass, it is expanded to show the effect of the sound emitter being above or below the player's position.

It should be noted that the information disclosed in the above background technology section is only used to enhance the understanding of the background of the present disclosure, and therefore may include information that does not constitute prior art known to those skilled in the art.

### SUMMARY

According to a first aspect of the present disclosure, there is provided a display control method in a game, where a graphical user interface is provided through a target terminal device, content displayed by the graphical user interface at least includes entire or partial game scene of the game, the game scene includes a target virtual character controlled by the target terminal device and a first virtual character controlled by another terminal device, and the method includes: acquiring monitoring parameter information of the target virtual character, and acquiring sound parameter information of the first virtual character; obtaining a sound monitoring result by calculating based on the monitoring parameter information and the sound parameter information, the sound monitoring result including whether a sound of the first virtual character can be monitored; when the sound of the first virtual character can be monitored, determining a corresponding mapping position on the graphical user interface according to a first position of the first virtual character in the game scene; and displaying an ideographic graph representing the first virtual character at the mapping position.

According to a second aspect of the present disclosure, there is provided an electronic device, including: a processor; a memory for storing computer readable instructions; wherein the processor is configured to execute the display control method in the game according to any one of the above embodiments by executing the computer readable instructions.

According to a third aspect of the present disclosure, there is provided a non-transitory computer-readable storage medium, with a computer program stored thereon, where the computer program implements the display control method in the game according to any one of the above embodiments when executed by a processor.

It should be understood that the above general description and the detailed description below are only for example and explanatory, and cannot limit the present disclosure.

### BRIEF DESCRIPTION OF THE DRAWINGS

FIG. 1 shows a schematic diagram of an interface for displaying a sound emitter in the related art;

FIG. 2 schematically shows a flowchart of a display control method in a game in one or more examples of the present disclosure;

FIG. 3 schematically shows a flowchart of a method for acquiring monitoring parameter information of a target virtual character in one example of the present disclosure;

FIG. 4 schematically shows a flowchart of a method for acquiring monitoring capability level of a target virtual character in one example of the present disclosure;

FIG. 5 schematically shows a flowchart of a method for acquiring noise level information of a target virtual character in one example of the present disclosure;

FIG. 6 schematically shows a flowchart of a method for calculating based on monitoring parameter information and sound parameter information in one example of the present disclosure;

FIG. 7 schematically shows a flowchart of a method for blurring a first virtual character in one example of the present disclosure;

FIG. 8 schematically shows a flowchart of a method for Gaussian blurring a first picture in one example of the present disclosure;

FIG. 9 schematically shows a schematic diagram of an interface showing a model outline of all regions of a first virtual character in one example of the present disclosure;

FIG. 10 schematically shows a schematic diagram of an interface showing a model outline of partial region of a first virtual character in one example of the present disclosure;

FIG. 11 schematically shows a schematic diagram of an interface showing model outlines of multiple first virtual characters in one example of the present disclosure;

FIG. 12 schematically shows a flowchart of a method for displaying ideographic graphs according to display duration in one example of the present disclosure;

FIG. 13 schematically shows a schematic diagram of an interface reflecting a position change of the first virtual character in real time in one example of the present disclosure;

FIG. 14 schematically shows a flowchart of a method for displaying a tracking control according to a sound monitoring result in one example of the present disclosure;

FIG. 15 schematically shows a structural schematic diagram of a display control device in a game in one example of the present disclosure;

FIG. 16 schematically shows an electronic device for implementing a display control method in a game in one example of the present disclosure;

FIG. 17 schematically shows a computer-readable storage medium for implementing a display control method in a game in one example of the present disclosure.

### DETAILED DESCRIPTION

Example embodiments will now be described more fully with reference to the accompanying drawings. However, example embodiments can be implemented in a variety of forms and should not be construed as limited to the examples set forth herein: rather, these embodiments are provided so that the disclosure will be more comprehensive and complete and the concepts of the example embodiments will be fully conveyed to those skilled in the art. The described features, structures, or characteristics may be combined in one or more embodiments in any suitable manner. In the following description, many specific details are provided to provide a full understanding of the embodiments of the present disclosure. However, those skilled in the art will appreciate that the technical solutions of the present disclosure may be practiced while omitting one or more of the specific details, or other methods, components, devices, steps, etc. may be employed. In other cases, known technical solutions are not shown or described in detail to avoid obscuring aspects of the present disclosure by overshadowing the main subject.

The terms “one”, “an”, “the” and “said” used in this specification are used to indicate the presence of one or more elements/components/etc.; the terms “including” and “having” are used to indicate an open-ended inclusion and mean that there may be other elements/components/etc. in addition to the listed elements/components/etc.; the terms “first” and “second” are used only as markers and are not intended to limit the number of their objects.

In addition, the accompanying drawings are only schematic illustrations of the present disclosure and are not necessarily drawn to scale. The same reference numerals in the drawings represent the same or similar parts, and their repeated descriptions will be omitted. Some of the block diagrams shown in the accompanying drawings are functional entities and do not necessarily correspond to physically or logically independent entities.

At present, visualizing sounds in games has become an important way to enhance the audiovisual effects of players and optimize the game experience of players. In shooting games, the visualization of sounds is mainly to display UI prompts at the top of the screen.

By combining with a compass or using a display logic similar to a compass, a volume bar graph is displayed at the compass position above the screen to mark the direction of the sound emission to remind the player of the direction of the sound emission. Further, based on the compass, it is expanded to show the effect of the sound emitter being above or below the player's position.

FIG. 1 shows a schematic diagram of an interface for displaying a sound emitter in the related art. As shown in FIG. 1, 200 indicates that the player is currently in the direction of 200°. The first diamond-shaped volume bar graph indicates that there is a sound emitter in the horizontal direction; the second volume bar graph presented in the horizontal direction downward indicates that there is a sound emitter below the player's position; and the third volume bar graph presented in the horizontal direction upward indicates that there is another sound emitter above the player's position.

In addition, a triangular symbol and curves at the end of the display, oriented horizontally to the right, indicate that there are other sound emitters beyond the current range of the compass.

However, this compass-based guidance method is normally displayed at the top of the HUD (Head Up Display). When the player's head is facing the sky or the ground, it is easy to misunderstand the direction, so the position of the sound can only be roughly pointed out. In addition, since it can only distinguish between above or below the player's position, and cannot distinguish whether it is the top of the head or the front position, it is impossible to accurately locate the sound above the player. Not to mention that this method is difficult to track the sound source in real time. Especially when the person making the sound and the listener are moving at the same time, if the HUD UI follows up in real time, the voiceprint UI will become blurred and the clarity of the information will be reduced. Furthermore, if multiple people make sounds at the same time in one direction, the HUD UI cannot display multiple voiceprints at the same time because it is difficult to track multiple sound sources at the same time, which will cause players to make misjudgments and degrade the player's gaming experience.

The display control method in the game in one embodiment of the present disclosure can be run on a local terminal device or a server. When the display control method in the game is run on a server, the method can be implemented and executed based on a cloud interaction system. The cloud interaction system includes a server and a client device.

In some examples of the present disclosure, various cloud applications can be run under the cloud interaction system, such as cloud games. Taking cloud games as an example, cloud games refer to a game method based on cloud computing. In the operation mode of cloud games, the executing subject of the game program and presenting subject of the game screen are separated. The storage and execution of the display control method in the game are completed on the cloud game server. The role of the client device is to receive and send data and present the game picture. For example, the client device can be a display device with data transmission function close to the user side, such as a mobile terminal, a TV, a computer, a handheld computer, etc.; but the cloud game server in the cloud is responsible for information processing. When playing the game, the player operates the client device to send an operation instruction to the cloud game server. The cloud game server runs the game according to the operation instruction, encodes and compresses the game pictures and other data, and returns them to the client device through the network. Finally, the client device decodes and outputs the game pictures.

In some examples of the present disclosure, taking the game as an example, the local terminal device stores the game program and is configured to present the game picture. The local terminal device is configured to interact with the player through a graphical user interface. That is, the game program is downloaded and installed and run by an electronic device in a conventional manner. The local terminal device can provide the graphical user interface to the player in a variety of ways. For example, it can be rendered and displayed on the display screen of the terminal, or provided to the player through holographic projection. For example, the local terminal device may include a display screen and a processor. The display screen is configured to present a graphical user interface. The graphical user interface includes a game picture. The processor is configured to run the game, generate a graphical user interface, and control the display of the graphical user interface on the display screen.

In a possible implementation, the embodiment of the present disclosure provides a display control method in a game, providing a graphical user interface through a terminal device. The terminal device may be the local terminal device mentioned above, or may be a client device in the cloud interaction system mentioned above.

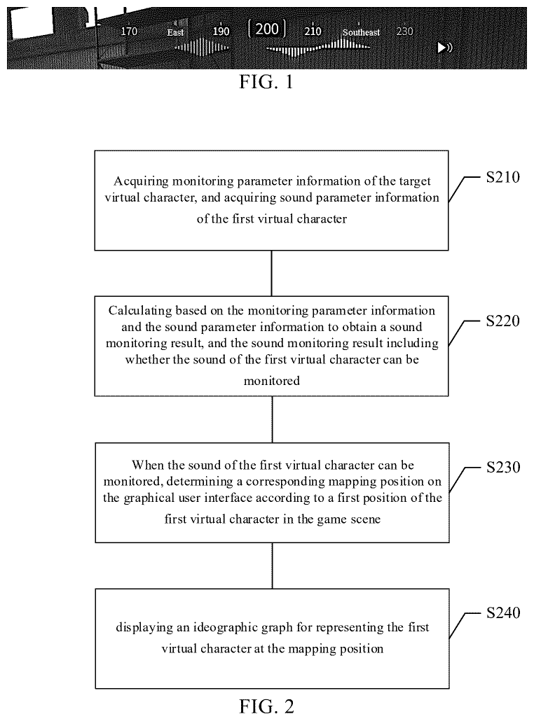

The present disclosure proposes a display control method in a game, providing a graphical user interface through a target terminal device. The content displayed by the graphical user interface at least includes entire or partial game scene of the game, and the game scene includes a target virtual character controlled by the target terminal device, and a first virtual character controlled by other terminal devices. FIG. 2 shows a flow chart of the display control method in the game. As shown in FIG. 2, the display control method in the game includes at least the following steps:

In step S210, acquiring monitoring parameter information of the target virtual character, and acquiring sound parameter information of the first virtual character.

In step S220, calculating based on the monitoring parameter information and the sound parameter information to obtain a sound monitoring result, and the sound monitoring result including whether the sound of the first virtual character can be monitored.

In step S230, when the sound of the first virtual character can be monitored, determining a corresponding mapping position on the graphical user interface according to a first position of the first virtual character in the game scene.

In step S240, displaying an ideographic graph for representing the first virtual character at the mapping position.

In one or more examples of the present disclosure, the monitoring parameter information of the target virtual character and the sound parameter information of the first virtual character are acquired as the data basis for rendering the ideographic graph, which enriches the data dimensions for rendering the ideographic graph, improves the dynamic degree and real-time performance of the ideographic graph rendering, improves the accuracy of the sound source positioning, and provides more realistic auditory and visual effects. Furthermore, the ideographic graph of the first virtual character is rendered and displayed according to the sound monitoring result, and the first virtual character is displayed in a fuzzy manner, accurately depicting the position of the first virtual character, while striking a balance with over-exposing the position of the first virtual character, and achieving the directional effect of real-time tracking and marking the first virtual character. When the ideographic graphs of multiple first virtual characters are rendered and displayed at the same time, the problem of being unable to track multiple sound sources in the same direction can be further solved, which is convenient for players to grasp the number of first virtual characters and optimize the game experience of players.

The following is a detailed description of each step of the display control method in the game.

In step S210, acquiring the monitoring parameter information of the target virtual character, and acquiring the sound parameter information of the first virtual character.

In one or more examples of the present disclosure, the target virtual character may be a game virtual character controlled by the current player through the target terminal device.

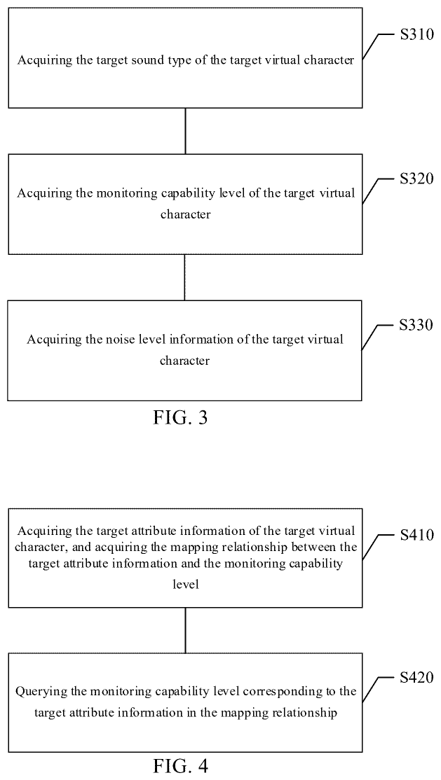

In some examples of the present disclosure, the monitoring parameter information includes a target sound type, a monitoring capability level and noise level information. FIG. 3 shows a flow chart of the method for acquiring the monitoring parameter information of the target virtual character. As shown in FIG. 3, the method may at least include the following steps: in step S310, acquiring the target sound type of the target virtual character.

The target sound type of the target virtual character is the sound type of the sound emitted by the target virtual character.

For example, the target sound type may include the type of movement of the target virtual character, the type of attack of the target virtual character and the type of preparation for attack of the target virtual character, etc. This example does not make special restrictions on this.

Specifically, the type of movement of the target virtual character may include running, squatting, jumping, slow walking and fast walking, etc.; the type of attack of the target virtual character may include shooting and throwing grenades, etc.; the type of preparation for attack of the target virtual character may include reloading, opening scopes and pulling out the safety pin of grenades, etc.

In step S320, acquiring the monitoring capability level of the target virtual character.

In some examples of the present disclosure, FIG. 4 shows a flow chart of a method for acquiring the monitoring capability level of the target virtual character. As shown in FIG. 4, the method may at least include the following steps: in step S410, acquiring the target attribute information of the target virtual character, and acquiring the mapping relationship between the target attribute information and the monitoring capability level.

The target attribute information of the target virtual character may be the game level of the target virtual character, or the number of tasks or task progress completed by the target virtual character to improve the monitoring capability level, etc., and this example does not make special restrictions on this.

In addition, a mapping relationship may be preset between the target attribute information and the monitoring capability level of the target virtual character.

The mapping relationship may be a unified relationship set for all game virtual characters, or a corresponding relationship set differently for different game virtual characters, and this example does not make special restrictions on this.

In step S420, querying the monitoring capability level corresponding to the target attribute information in the mapping relationship.

After acquiring the mapping relationship between the target attribute information and the monitoring capability level of the target virtual character, the monitoring capability level corresponding to the current target attribute information of the target virtual character may be queried in the mapping relationship.

The monitoring capability level can also be used as the growth value of the target virtual character to improve the long-term retention effect of the player.

In this example, the monitoring capability level of the target virtual character can be obtained by querying the mapping relationship between the target attribute information and the monitoring capability level. The determination method is simple and accurate, and the data information of the target virtual character is provided for displaying the ideographic graph of the first virtual character.

In step S330, acquiring the noise level information of the target virtual character.

In some examples of the present disclosure, FIG. 5 shows a flow chart of a method for acquiring the noise level information of the target virtual character. As shown in FIG. 5, the method may at least include the following steps: in step S510, obtaining the target sound intensity emitted by the target virtual character according to the target sound type, and obtaining the monitoring noise threshold of the target virtual character according to the target sound type.

Since corresponding sound intensities are set for different target sound types, the corresponding target sound intensity can be determined according to the obtained target sound type of the target virtual character.

For example, when the target sound type is running, the corresponding target sound intensity is 30 decibels; and when the target sound type is shooting, the corresponding target sound intensity may be 40 decibels.

Since corresponding monitoring noise thresholds are also set for different target sound types, the corresponding monitoring noise threshold may be determined according to the acquired target sound type of the target virtual character.

The monitoring noise threshold may be used to characterize the maximum sound intensity that can be monitored when the target virtual character emits the target sound intensity.

For example, when the target sound type is running, the corresponding monitoring noise threshold may be 20 decibels; and when the target sound type is shooting, the corresponding monitoring noise threshold may be 10 decibels.

In step S520, comparing the target sound intensity and the monitoring noise threshold to obtain a comparison result, and determining the noise level information of the target virtual character according to the comparison result.

After acquiring the target sound intensity and the monitoring noise threshold respectively according to the target sound type, the target sound intensity and the monitoring noise threshold may be compared to obtain a comparison result.

Further, the noise level information of the target virtual character is determined according to the comparison result.

When the comparison result is that the target sound intensity is less than or equal to the monitoring noise threshold, it indicates that the target virtual character can monitor the sound emitted by the first virtual character corresponding to the target virtual character.

When the comparison result is that the target sound intensity is greater than the monitoring noise threshold, it indicates that the target virtual character itself emits too much noise, so the first virtual character corresponding to the target virtual character cannot be monitored.

Therefore, the acquisition of the noise level information can be more in line with the actual scene such as if the target virtual character is shooting, it is more difficult to capture the gunshot in the environment, and the simulation effect is more realistic.

In this example, the noise level information of the target virtual character can be determined by comparing the target sound intensity and the monitoring noise threshold, which provides a judgment basis for whether the first virtual character can be monitored, and also provides a prerequisite judgment basis for displaying the ideographic graphs of the first virtual character.

In addition, in a case where the target virtual character does not make a sound, the corresponding noise level information can be directly determined.

In some examples of the present disclosure, when the target virtual character does not make a sound, the noise level information of the target virtual character is determined.

When the target virtual character does not make a sound, it indicates that the target virtual character will not generate noise to affect the monitoring. Therefore, the current noise level information of the target virtual character can be directly determined to represent that it is able to monitor the sound emitted by the first virtual character corresponding to the target virtual character.

On the other hand, the sound parameter information of one or more first virtual characters corresponding to the target virtual character can also be obtained at the same time to track one or more sound sources at the same time, so that the player controlling the target virtual character can accurately obtain the quantity information of the first virtual characters.

The first virtual character can be one or more game virtual characters determined from the game virtual characters of the enemy camp of the target virtual character, or one or more game virtual characters of teammates belonging to the same camp as the target virtual character, and this example does not make special restrictions on this.

In some examples of the present disclosure, the sound parameter information includes: a first sound type and a sound propagation distance. The first sound type includes: a first movement type, a first attack type, and a first preparation for attack type.

The first sound type can include the first movement type, the first attack type, and the first preparation for attack type, and this example does not make special restrictions on this.

The sound propagation distance can be a distance moved by the first virtual character to reach the same position of the target virtual character, that is, a distance between the first virtual character and the target virtual character in the current situation.

Specifically, the first movement type may include movement modes such as the first virtual character running, squatting, jumping, slow walking and fast walking. The first attack type may include attack modes such as the first virtual character shooting and throwing grenades. The first preparation for attack type may include preparation modes before attack modes such as the first virtual character reloading, opening scopes and pulling safety pins of grenades.

Therefore, the acquisition of the first sound type of the first virtual character can provide data support for the effect that the sharp sniper rifle shot sound is easier to capture than the short submachine gun sound or running sound, and the sound propagation distance can affect the visualization ability of the ideographic graph of the first virtual character.

In step S220, calculating based on the monitoring parameter information and the sound parameter information and obtaining the sound monitoring result, and the sound monitoring result including whether the sound of the first virtual character can be monitored.

In the example of the present disclosure, after respectively obtaining the monitoring parameter information of the target virtual character and the sound parameter information of the enemy first character, the monitoring parameter information and the sound parameter information of different first virtual characters can be calculated in parallel to obtain the sound monitoring result of the target virtual character, so as to ensure the simultaneous tracking and rendering of the ideographic graphs of multiple sound sources.

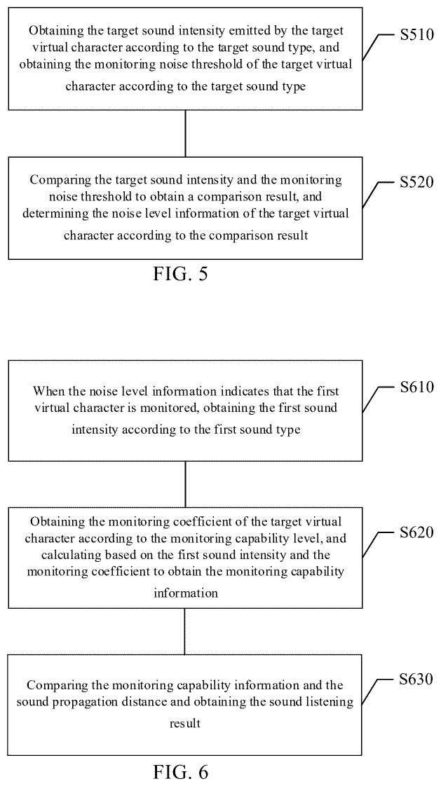

In some examples of the present disclosure, the monitoring parameter information includes monitoring capability level and noise level information. The sound parameter information includes the first sound type and the sound propagation distance. FIG. 6 shows a flow chart of a method for calculating based on the monitoring parameter information and the sound parameter information. As shown in FIG. 6, the method may at least include the following steps: in step S610, when the noise level information indicates that the first virtual character is monitored, obtaining the first sound intensity according to the first sound type.

When the target sound intensity of the target virtual character is less than or equal to the monitoring noise threshold, or when the target virtual character does not make a sound, the noise level information indicates that the first virtual character can be monitored at this time.

In this case, since corresponding first sound intensity is also set for different first sound type, the first sound intensity at this time can be obtained according to the first sound type obtained.

For example, when the first sound type is running, the corresponding first sound intensity is 30 decibels; when the first sound type is shooting, the corresponding first sound intensity can be 40 decibels.

In step S620, obtaining the monitoring coefficient of the target virtual character according to the monitoring capability level, and calculating based on the first sound intensity and the monitoring coefficient to obtain the monitoring capability information.

Since the corresponding monitoring coefficient is set in a manner linearly related to the monitoring capability level, the corresponding monitoring coefficient can be obtained after the monitoring capability level of the target virtual character is obtained.

Further, the corresponding monitoring capability information can be obtained by calculating based on the first sound intensity and the monitoring coefficient.

Specifically, the first sound intensity and the monitoring coefficient can be calculated by multiplying the first sound intensity and the monitoring coefficient, or other calculation methods can be set according to actual conditions, and this example does not make special restrictions on this.

In step S630, comparing the monitoring capability information and the sound propagation distance and obtaining the sound monitoring result.

After acquiring the monitoring capability information, the monitoring capability information and the obtained sound propagation distance can be compared to obtain the sound monitoring result.

The sound monitoring result can be that the monitoring capability information is greater than or equal to the sound propagation distance, or that the monitoring capability information is less than the sound propagation distance.

The determination of the sound monitoring result and the previous judgment process form a double logical and rigorous judgment level for displaying the ideographic graph of the first virtual character, and the judgment level can be represented by formula (1):

$$∀ {X}_{b 1} <= {Y}_{a 1} \& {X}_{a 1} * {M}_{b 2} >= dS ( a 2 , b 2 ) \qquad ( 1 )$$

where, b2∈U_a2, U represents a set of first virtual characters that the target virtual character can monitor, a1 represents the first sound type, b1 represents the target sound type, a2 represents the first virtual character that makes the sound, b2 represents the target virtual character, X represents the target sound intensity of the target virtual character or the first sound intensity of the first virtual character, Y represents the monitoring noise threshold, M represents the monitoring coefficient, and dS represents the sound propagation distance.

In this example, by calculating and comparing the first sound intensity and the monitoring coefficient, the sound monitoring result can be further determined, and whether the first virtual character cannot be monitored due to the distance is too far can be judged, which is more in line with the actual situation and accurate, and a balance is achieved between displaying the ideographic graph of the first virtual character and ensuring the safety of the first virtual character.

In the process of acquiring the sound monitoring result, data of various dimensions are added to the calculation process, which provides support for the optimization of the corresponding voiceprint system, increases the depth of the voiceprint system in the later numerical growth, and provides guarantees for different experiences of the voiceprint system. For example, listeners of different levels can obtain different amounts of information, etc. from the same sound, which changes the player's later game strategy.

In step S230, when the sound of the first virtual character can be monitored, the corresponding mapping position on the graphical user interface is determined according to the first position of the first virtual character in the game scene.

In one or more examples of the present disclosure, after acquiring the sound monitoring result, if the sound monitoring result is that the sound of the first virtual character can be monitored, the corresponding mapping position can be determined according to the first position of the first virtual character in the game scene.

In some examples of the present disclosure, the mapping position corresponding to the first position on the graphical user interface is determined according to the first position of the first virtual character in the game scene and the camera parameters of the virtual camera; where the virtual camera is configured to capture entire or partial game scene of the game to obtain the game scene picture displayed on the graphical user interface.

The game scene picture displayed on the graphical user interface of the target terminal device is the game scene content captured by the virtual camera.

For example, in a first-person game, the virtual camera can be set on the head of the target virtual character, and the camera parameters such as the direction of the virtual camera rotate with the rotation of the target virtual character, and the game scene picture rendered on the graphical user interface is equivalent to the game scene content captured by the virtual camera.

In a third-person game, the virtual camera can be set above or behind the target virtual character, and the camera parameters such as the direction of the virtual camera move with the movement of the target virtual character, so as to capture the game scene of a certain area around the target virtual character at a fixed angle.

Therefore, when determining the mapping position corresponding to the first position of the first virtual character in the game scene, it may be determined by the camera parameters such as the direction of the virtual camera of the target virtual character, that is, determined by the perspective of the target virtual character.

Specifically; the mapping position corresponding to the first position can be the same position as the first position, or it can be other associated positions, and this example does not make special restrictions on this.

In step S240, displaying an ideographic graph representing the first virtual character at the mapping position.

In the example of the present disclosure, after determining that the sound monitoring result is that the sound of the first virtual character can be monitored and determining the mapping position, the ideographic graph of the first virtual character can be displayed at the mapping position.

In some examples of the present disclosure, the non-visible area of the first virtual character for the target virtual character is determined according to the camera parameters, and a ideographic graph representing the non-visible area of the first virtual character is displayed at the mapping position. The non-visible area includes entire or partial area of the first virtual character, and the part of the area of the first virtual character includes one or more virtual body parts of the first virtual character.

When observing the first virtual character from the perspective of the target virtual character according to the camera parameters of the virtual camera, it may happen that the target virtual character can observe the entire first virtual character, or that the target virtual character can only see part of the first virtual character.

Then, in order to generate the ideographic graph of the first virtual character according to the perspective of the target virtual character, the non-visible area of the first virtual character from the perspective of the target virtual character can be determined according to the camera parameters.

The non-visible area is an area of the first virtual character that the target virtual character cannot see.

When the target virtual character cannot observe the first virtual character, the non-visible area is the entire area of the first virtual character, that is, the entire first virtual character is a non-visible area. When the target virtual character can observe partial area such as the head of the first virtual character, the non-visible area is the non-visible area of the first virtual character, that is, other areas except the head.

Therefore, the non-visible area of the first virtual character can be one or more virtual body parts of the first virtual character.

It is to be noted that the division of the non-visible area is not strictly based on the virtual body parts of the first virtual character, but is the same as the real perspective in the actual scene. It may appear that part of a virtual body part is visible and the other part is non-visible.

After determining the non-visible area of the first virtual character for the target virtual character, an ideographic graph representing the non-visible area of the first virtual character can be generated to display the ideographic graph.

In some examples of the present disclosure, the first virtual character is fuzzy processed to obtain an ideographic graph representing the first virtual character, and the ideographic graph is displayed at the mapping position.

It is to be noted that the portion of the first virtual character that is blurred is the non-visible area of the first virtual character, and the visible area of the first virtual character for the target virtual character does not need to be blurred.

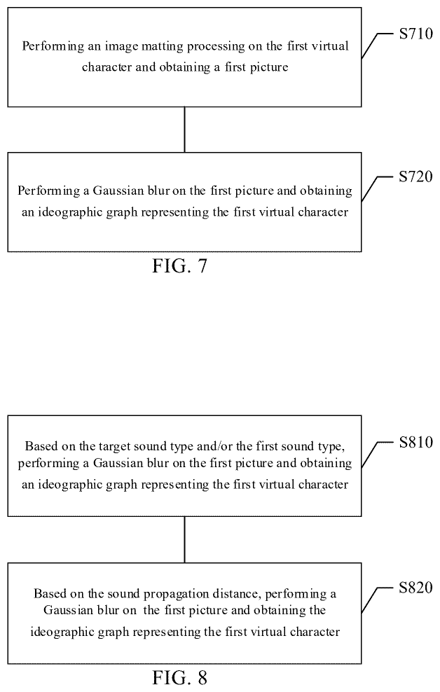

In some examples of the present disclosure, FIG. 7 shows a flow chart of a method for blurring the first virtual character. As shown in FIG. 7, the method may at least include the following steps: in step S710, performing an image matting processing on the first virtual character and obtaining a first picture.

The first virtual character is subjected to an image matting process by using a portrait segmentation technique or an intelligent image matting technique to obtain a first picture of the first virtual character. The first picture may be a picture formed based on the outline of the first character and its interior.

In step S720, performing a Gaussian blur on the first picture and obtaining an ideographic graph representing the first virtual character.

Gaussian Blur, also known as Gaussian smoothing, is a processing effect widely used in image processing software such as Adobe Photoshop (an image processing software), GIMP (GNU Image Manipulation Program) and Paint.NET (an image and photo processing software), and is usually used to reduce image noise and reduce detail levels.

The image produced by this blurring technique is visualized like looking through a hairy glass, which is significantly different from the lens out-of-focus bokeh effect and the effect in the shadows of ordinary lighting.

Gaussian smoothing is also used in the pre-processing stage of computer vision algorithms to enhance the image effect at different scales. From a mathematical point of view, the Gaussian blurring process of an image is a convolution of the image with a normal distribution. Since the normal distribution is also called the Gaussian distribution, this technique is called Gaussian blurring.

Convolving the image with a circular box blur will produce a more accurate out-of-focus effect. Since the Fourier transform of the Gaussian function is another Gaussian function, the Gaussian blur is a low-pass filter for the image.

Gaussian blur is an image blurring filter that uses the normal distribution to calculate the transformation of each pixel in the image. The equation for the normal distribution in N-dimensional space is:

$$G ( r ) = \frac{1}{{\sqrt{2 π {σ}^{2}}}^{N}} {e}^{- {r}^{2} / ( 2 {σ}^{2} )} \qquad ( 2 )$$

The two-dimensional space for Gaussian blurring of the enemy's outline picture is defined as:

$$G ( u , v ) = \frac{1}{2 {πσ}^{2}} {e}^{- ( {u}^{2} + {v}^{2} ) / ( 2 {σ}^{2} )} \qquad ( 3 )$$

where r is the blur radius and o is the standard deviation of the normal distribution.

In two-dimensional space, the contour lines of the surface generated by this formula are concentric circles that are normally distributed starting from the center. The convolution matrix composed of pixels with non-zero distribution is transformed with the original image. The value of each pixel is the weighted average of the values of the surrounding adjacent pixels. The value of the original pixel has the largest Gaussian distribution value, so it has the largest weight. The weights of the adjacent pixels become smaller and smaller as they are farther away from the original pixel.

The blur processing performed in this way retains the edge effect more highly than other equalization blur filters.

In some examples of the present disclosure, the monitoring parameter information includes the target sound type. The sound parameter information includes the first sound type and the sound propagation distance. FIG. 8 shows a flow chart of a method for performing Gaussian blur on the first picture. As shown in FIG. 8, the method may at least include the following steps: in step S810, based on the target sound type and/or the first sound type, performing a Gaussian blur on the first picture and obtaining an ideographic graph representing the first virtual character. The blur parameter of the ideographic graph is determined according to the target sound type and/or the first sound type. The blur parameter includes the size and/or clarity of the ideographic graph.

The degree of Gaussian blur is determined by the Gaussian matrix. Specifically, the larger the size of the Gaussian matrix, the larger the standard deviation, and the greater the blurriness of the ideographic graph obtained by Gaussian blur.

Generally, the standard deviation can be set to 0 to perform Gaussian blur. Therefore, the blurriness of the ideographic graph obtained by Gaussian blur is determined by the Gaussian matrix.

Then, when determining the Gaussian matrix for generating the ideographic graph, it can be determined according to the target sound type and/or the first sound type, so the blur parameter reflecting the blurriness of the ideographic graph is determined by the target sound type and/or the first sound type.

For example, there can be a mapping relationship between different target sound types and the size of the Gaussian matrix, so the size of the Gaussian matrix can be determined according to the mapping relationship and the target sound type, so as to perform Gaussian blur on the first picture through the target sound type to obtain the corresponding ideographic graph.

Similarly, there can also be a corresponding mapping relationship between different first sound types and the size of the Gaussian matrix, so the size of the Gaussian matrix can be determined according to the mapping relationship and the first sound type, so as to perform Gaussian blur on the first picture through the first sound type to obtain the corresponding ideographic graph.

Alternatively, different target sound types and the first sound types simultaneously determine the size of the Gaussian matrix to obtain the corresponding ideographic graph.

Then, the blur parameter reflecting the blur degree of the ideographic graph may include the size and/or clarity of the ideographic graph.

When the Gaussian matrix determined by the target sound type and/or the first sound type is larger, it can be determined that the size of the ideographic graph is smaller and/or the clarity is worse. When the Gaussian matrix determined by the target sound type and/or the target sound type is smaller, it can be determined that the size of the ideographic graph is larger and/or the clarity is better.

In step S820, based on the sound propagation distance, performing a Gaussian blur on the first picture and obtaining the ideographic graph representing the first virtual character. The blur parameter of the ideographic graph is determined according to the sound propagation distance, and the blur parameter includes the size and/or clarity of the ideographic graph.

The degree of Gaussian blur is determined by the Gaussian matrix. Specifically, the larger the size of the Gaussian matrix, the larger the standard deviation, and the greater the blur degree of the ideographic graph obtained by Gaussian blur.

Generally, the standard deviation can be set to 0 to directly perform Gaussian blur. Therefore, the blur degree of the ideographic graph generated by Gaussian blur is determined by the Gaussian matrix.

Then, when determining the Gaussian matrix for generating the ideographic graph, it can be determined according to the sound propagation distance, and therefore, the blur parameter reflecting the blur degree of the ideographic graph is determined by the sound propagation distance.

For example, the size of the Gaussian matrix can be directly equal to the size of the sound propagation distance. Or there can be a mapping relationship between the size of the Gaussian matrix and the sound propagation distance, and therefore, the size of the Gaussian matrix can be determined according to the mapping relationship and the sound propagation distance, so as to perform Gaussian blur on the first picture by the sound propagation distance to obtain the corresponding ideographic graph.

Then, the blur parameter reflecting the blur degree of the ideographic graph can include the size and/or clarity of the ideographic graph.

When the Gaussian matrix determined by the sound propagation distance is larger, it can be determined that the size of the ideographic graph is smaller and/or the clarity is worse; when the Gaussian matrix determined by the sound propagation distance is smaller, it can be determined that the size of the ideographic graph is larger and/or the clarity is better.

Therefore, by blurring the first virtual character, it is possible to make the contour position information of the first virtual character more blurred the farther away it is, which better simulates the difficulty of judging distant sounds in the real world.

Moreover, when the first virtual character is an enemy virtual character, the ideographic graph after blurring will not accurately display the position of the enemy virtual character, reducing the possibility of the enemy virtual character being accurately killed. Furthermore, when the sound of the enemy virtual character is monitored, the ideographic graph of the enemy virtual character will be rendered on the enemy virtual character in real time, achieving a real-time visualization effect.

After generating the ideographic graph representing the first virtual character, the ideographic graph can be displayed at the determined mapping position.

In some examples of the present disclosure, the ideographic graph is the model outline of the first virtual character.

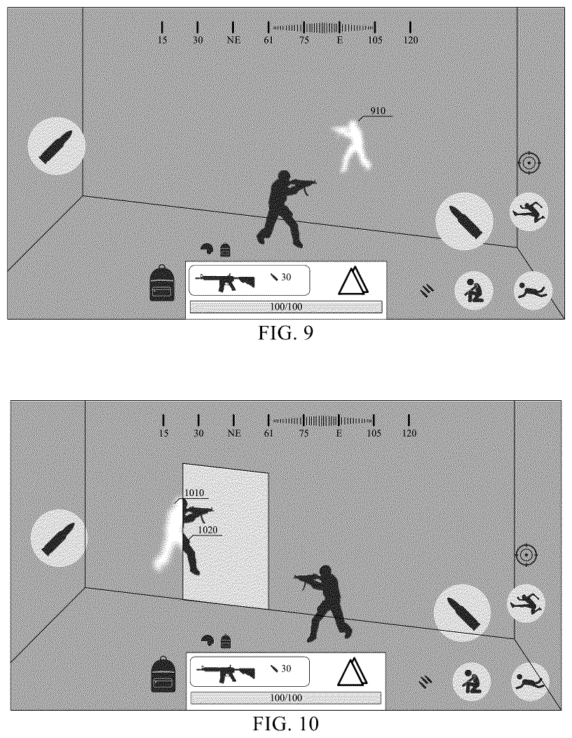

FIG. 9 shows a schematic diagram of an interface showing the model outline of the entire area of the first virtual character. As shown in FIG. 9, when the first virtual character is an enemy virtual character, 910 is the ideographic graph of the enemy virtual character. The ideographic graph is the model outline of the first virtual character obtained by blurring the entire area of the first virtual character.

FIG. 10 shows a schematic diagram of an interface showing the model outline of a partial area of the first virtual character. As shown in FIG. 10, when the first virtual character is an enemy virtual character, 1010 is the ideographic graph of the enemy virtual character. The ideographic graph is the model outline of the first virtual character obtained by blurring part of the area of the first virtual character.

1020 is the normal display picture of the enemy virtual character of other areas except for the non-visible area. Since the other areas represented by 1020 are visible to the target virtual character, there is no need to blur 1020.

In order to display the model outline of the enemy virtual character, the display priority of the model outline can be set to the highest, so that the model outline is at the top of the game scene and will not be blocked by the walls or other obstacles in the game, providing a perspective effect display method for the model outline.

At the same time, the blurred model outline also solves the problem of not exposing too much information of the enemy virtual character and over-exposing the position information of the enemy virtual character, such as the accurate position information of the enemy virtual character, including the head position and body orientation, so as to avoid the player who controls the target virtual character from using the perspective effect to lock the head and other operations that destroy the balance of the game.

FIG. 11 shows a schematic diagram of an interface for displaying model outlines of multiple first virtual characters. As shown in FIG. 11, when the first virtual character is an enemy virtual character, 1110, 1120, 1130, 1140 and 1150 are ideographic graphs of five enemy virtual characters. The ideographic graphs are model outlines of the first virtual characters obtained by simultaneously performing blur processing on the five enemy virtual characters.

Therefore, multiple sound monitoring results can be obtained by parallel calculation and processing of the sound parameter information of multiple different first virtual characters, ensuring simultaneous tracking and rendering of ideographic graphs of multiple first virtual characters.

Moreover, due to the different target sound types and/or first sound types of different first virtual characters, as well as the different sound propagation distances, the Gaussian blur degrees of different first virtual characters are different, so the sizes and/or clarities of the model outlines of the first virtual characters will have certain differences.

In addition, the ideographic graph can also be other graphic related to the model outline.

In some examples of the present disclosure, the ideographic graph is graphic obtained by performing blur processing on the model outline of the first virtual character.

After generating the ideographic graph representing the first virtual character, in order to further protect the position information of the first virtual character, the model contour that has been blurred can be further blurred to obtain the ideographic graph.

In addition, the generated ideographic graph can also be subjected to other deformation processing according to actual conditions, and this example does not make special restrictions on this.

Further, the display duration of the ideographic graph can also be determined according to the monitoring parameter information and/or the sound parameter information.

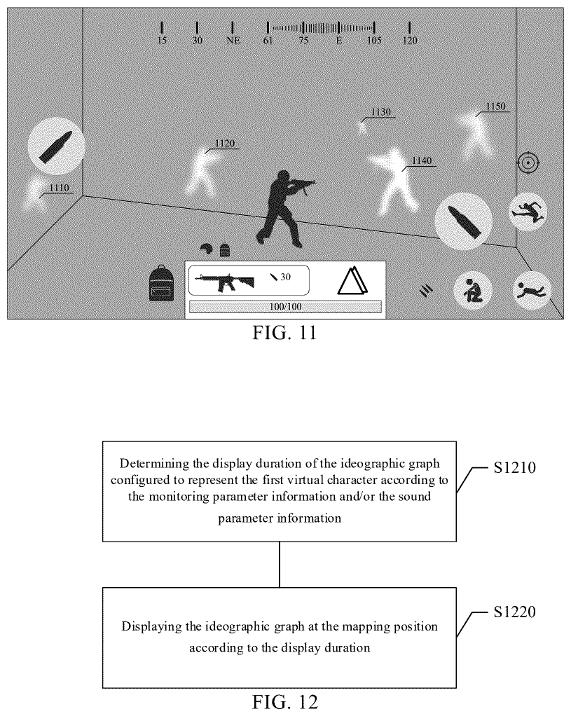

In some examples of the present disclosure, FIG. 12 shows a flow chart of a method for displaying an ideographic graph according to the display duration. As shown in FIG. 12, the method can at least include the following steps: in step S1210, determining the display duration of the ideographic graph configured to represent the first virtual character according to the monitoring parameter information and/or the sound parameter information.

The display duration of the ideographic graph can be related to the first sound type of the first virtual character and the monitoring capability level of the target virtual character.

For example, the display duration corresponding to the first sound type of the first virtual character being the first attack type may be greater than the display duration corresponding to the first sound type being the first preparation for attack type, and the display duration corresponding to the first sound type of the first virtual character being the first preparation for attack type is greater than the display duration corresponding to the first sound type being the first movement type.

Or, the monitoring capability level of the target virtual character is positively correlated with the display duration of the ideographic graph. For example, the higher the monitoring capability level of the target virtual character, the longer the display duration of the ideographic graph; the lower the monitoring capability level of the target virtual character, the shorter the display duration of the ideographic graph.

In addition, the display duration of the ideographic graph may also be related to the first sound type of the first virtual character and the monitoring capability level of the target virtual character, etc., and this example does not make special restrictions on this.

In step S1220, displaying the ideographic graph at the mapping position according to the display duration.

After determining the display duration of the ideographic graph, the ideographic graph of the first virtual character may be displayed according to the display duration.

In this example, when the first virtual character is monitored, the duration of the display of the ideographic graph of the first virtual character can present differentiated performance according to the monitoring parameter information and/or the sound parameter information, thereby increasing the depth and long-term development experience of the entire system.

In order to track the sound source of the first virtual character in real time, the mapping position may be updated in real time through the change of the first position.

In some examples of the present disclosure, in response to the change of the first position, the mapping position is updated in real time, thereby updating the display position of the ideographic graph on the graphical user interface, so that the ideographic graph reflects the position change of the first virtual character in real time.

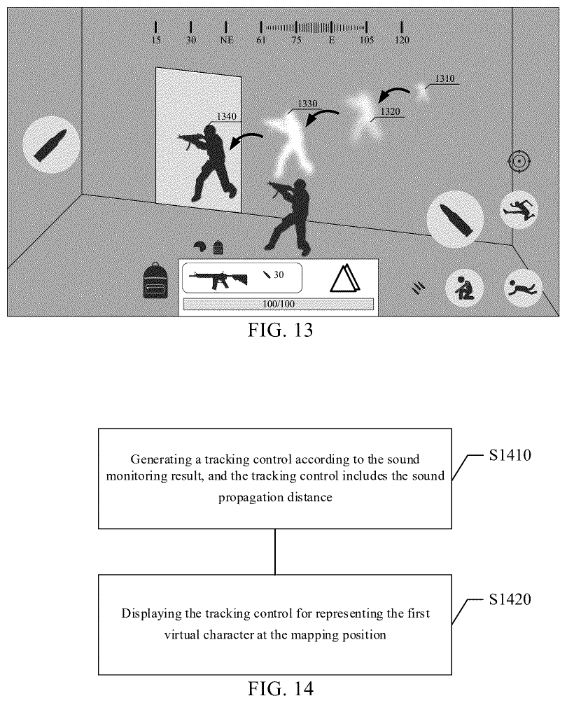

FIG. 13 shows a schematic diagram of an interface that reflects the position change of the first virtual character in real time. As shown in FIGS. 13, 1310, 1320 and 1330 are ideographic graphs of the first virtual character at different times. The ideographic graphs are obtained by updating the mapping position in real time according to the change of the first position of the first virtual character at different times, so as to display the model outline of the current time at the corresponding mapping position.

Therefore, the ideographic graphs at different times can reflect the position change of the first virtual character and track and display the display position of the first virtual character on the graphical user interface in real time.

Among them, 1310, 1320 and 1330 are the model outlines obtained by blurring the entire area of the first virtual character when the entire first virtual character is a non-visible area.

Through the accurate depiction and rendering of the ideographic graph of the first virtual character, it is convenient for players to grasp the direction of the sound source in real time and intuitively, and accurately understand the orientation of multiple dimensions including left and right, up and down, and near and far, solving the problem that the sound direction can only show the approximate position and cannot achieve real-time tracking.

In addition, 1340 is a game picture that is displayed normally when the entire first virtual character is visible to the target virtual character, and no area of the first virtual character is blurred.

Therefore, it may also happen that the target virtual character can observe the entire first virtual character, then there is no non-visible area.

In some examples of the present disclosure, it is determined according to the camera parameters that the entire area of the first virtual character is visible to the target virtual character, and the ideographic graph used to represent the first virtual character is not displayed.

When the target virtual character observes the entire first virtual character, there is no non-visible area. That is, the entire area of the first virtual character is visible to the target virtual character.

In this case, there is no need to further generate an ideographic graph configured to represent the first virtual character, nor is there a need to display the ideographic graph. When the first virtual character is monitored, in addition to being able to generate and display the ideographic graph of the first virtual character according to the sound monitoring result, a tracking control can also be displayed according to the sound monitoring result.

In some examples of the present disclosure, the sound parameter information includes sound propagation distance. FIG. 14 shows a flow chart of a method for displaying a tracking control according to a sound monitoring result. As shown in FIG. 14, the method may at least include the following steps: in step S1410, generating a tracking control according to the sound monitoring result, and the tracking control includes the sound propagation distance.

When the sound monitoring result is that the monitoring capability information is greater than or equal to the sound propagation distance, a tracking control may be generated. The tracking control may be in the form of a 2D UI, such as a circular control, a square control, or an arrow-style control, etc., and this example does not make special restrictions on this.

The position of the first virtual character may be tracked in real time through the tracking control.

Moreover, in order to further display the distance between the first virtual character indicated by the tracking control and the target virtual character, the information of the sound propagation distance may be added on the tracking control, or at a relevant position such as next to the tracking control.

In step S1420, displaying a tracking control for representing the first virtual character at the mapping position.

After determining the mapping position and generating the tracking control, the tracking control may be displayed at the mapping position.

At this time, the mapping position can be the internal position of the first virtual character such as the head or chest of the first virtual character, or the external position such as the left or right side of the first virtual character, and this example does not make special restrictions on this.

In this example, by displaying the generated tracking control at the mapping position of the first virtual character, another implementation method is provided for real-time tracking and rendering of the sound source, enriching the display effect of the sound source and improving the game experience of the player.

In the display control method in the game in the example of the present disclosure, the monitoring parameter information of the target virtual character and the sound parameter information of the first virtual character are obtained as the data basis for rendering the ideographic graph, enriching the data dimensions for rendering the ideographic graph, improving the dynamic degree and real-time performance of the ideographic graph rendering. improving the accuracy of the sound source positioning, and providing more realistic auditory and visual effects. Furthermore, the ideographic graph of the first virtual character is rendered and displayed according to the sound monitoring results, the first virtual character is displayed in a fuzzy manner, accurately depicting the position of the first virtual character, while striking a balance with over-exposing the position of the first virtual character, and achieving the directional effect of real-time tracking and marking the first virtual character. When the ideographic graphs of multiple first virtual characters are rendered and displayed at the same time, the problem of being unable to track multiple sound sources in the same direction can be further solved, which is convenient for players to grasp the number of first virtual characters and optimize the game experience of players.

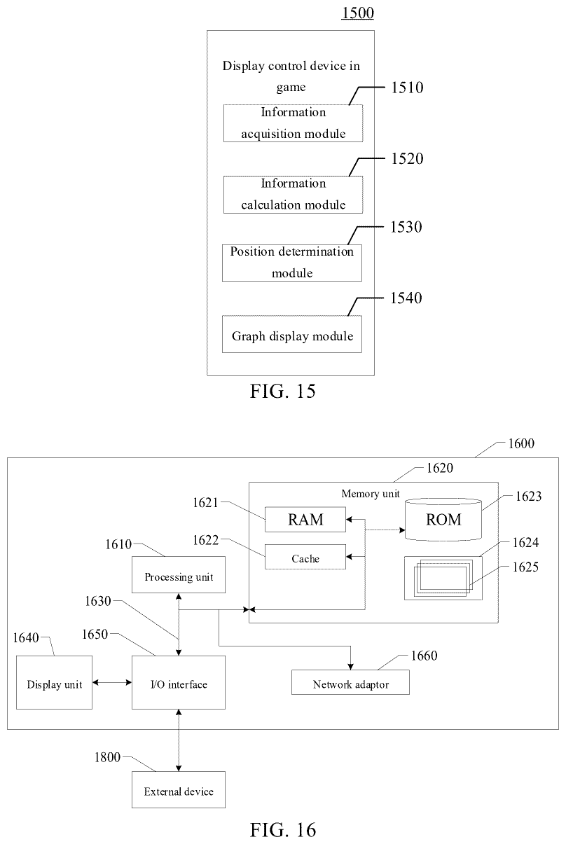

In addition, in one or more examples of the present disclosure, a display control device in a game is also provided, which provides a graphical user interface through a target terminal device, and the content displayed by the graphical user interface at least includes entire or partial game scene of the game, and the game scene includes a target virtual character controlled by the target terminal device, and a first virtual character controlled by other terminal devices. FIG. 15 shows a schematic diagram of the structure of a display control device in a game. As shown in FIG. 15, the display control device 1500 in the game may include: an information acquisition module 1510, an information calculation module 1520, a position determination module 1530, and a graph display module 1540. The information acquisition module 1510 is configured to acquire the monitoring parameter information of the target virtual character and acquire the sound parameter information of the first virtual character. The information calculation module 1520 is configured to calculate the monitoring parameter information and the sound parameter information to obtain the sound monitoring result, and the sound monitoring result includes: whether the sound of the first virtual character can be monitored. The position determination module 1530 is configured to determine the corresponding mapping position on the graphical user interface according to the first position of the first virtual character in the game scene when the sound of the first virtual character can be monitored. The graph display module 1540 is configured to display the ideographic graph representing the first virtual character at the mapping position.

In one or more examples of the present disclosure, the monitoring parameter information includes a target sound type, a monitoring capability level and noise level information. Acquiring the monitoring parameter information of the target virtual character includes: acquiring the target sound type of the target virtual character; acquiring the monitoring capability level of the target virtual character; acquiring the noise level information of the target virtual character.

In one or more examples of the present disclosure, acquiring the monitoring capability level of the target virtual character includes: acquiring the target attribute information of the target virtual character, and acquiring the mapping relationship between the target attribute information and the monitoring capability level; querying the monitoring capability level corresponding to the target attribute information in the mapping relationship.

In one or more examples of the present disclosure, acquiring the noise level information of the target virtual character includes: acquiring the target sound intensity emitted by the target virtual character according to the target sound type, and acquiring the monitoring noise threshold of the target virtual character according to the target sound type; comparing the target sound intensity and the monitoring noise threshold to obtain a comparison result, and determining the noise level information of the target virtual character according to the comparison result.

In one or more examples of the present disclosure, the method further includes: when the target virtual character does not emit a sound, determining the noise level information of the target virtual character.

In one or more examples of the present disclosure, the sound parameter information includes a first sound type and a sound propagation distance, and the first sound type includes at least one of the following types: a first movement type, a first attack type, and a first preparation for attack type.

In one or more examples of the present disclosure, the monitoring parameter information includes monitoring capability level and noise level information. The sound parameter information includes a first sound type and a sound propagation distance. Obtaining the sound monitoring result by calculating based on the monitoring parameter information and the sound parameter information includes: when the noise level information indicates that the first virtual character is monitored, obtaining a first sound intensity according to the first sound type: obtaining a monitoring coefficient of the target virtual character according to the monitoring capability level, and calculating based on the first sound intensity and the monitoring coefficient to obtain the monitoring capability information; comparing the monitoring capability information and the sound propagation distance to obtain the sound monitoring result.

In one or more examples of the present disclosure, the ideographic graph is a model outline of the first virtual character.

In one or more examples of the present disclosure, the ideographic graph is a graph obtained by blurring the model outline of the first virtual character.

In one or more examples of the present disclosure, determining the corresponding mapping position on the graphical user interface according to the first position of the first virtual character in the game scene includes: determining the corresponding mapping position of the first position on the graphical user interface according to the first position of the first virtual character in the game scene and the camera parameters of the virtual camera; where the virtual camera is configured to capture entire or partial game scene of the game to obtain the game scene picture displayed on the graphical user interface.

In one or more examples of the present disclosure, displaying the ideographic graph representing the first virtual character at the mapping position includes: determining the non-visible area of the first virtual character for the target virtual character according to the camera parameters, and displaying the ideographic graph representing the non-visible area of the first virtual character at the mapping position; where the non-visible area includes entire or partial area of the first virtual character, and the part of the area of the first virtual character includes one or more virtual body parts of the first virtual character.

In one or more examples of the present disclosure, the method further includes: determining that the entire area of the first virtual character is visible to the target virtual character according to the camera parameters, and not displaying the ideographic graph representing the first virtual character.

In one or more examples of the present disclosure, displaying the ideographic graph representing the first virtual character at the mapping position includes: performing a blur process on the first virtual character to obtain the ideographic graph representing the first virtual character, and displaying the ideographic graph at the mapping position.

In one or more examples of the present disclosure, performing the blur process on the first virtual character to obtain the ideographic graph representing the first virtual character includes: obtaining a first picture by performing an image matting process on the first virtual character; performing a Gaussian blur on the first picture to obtain the ideographic graph representing the first virtual character.

In one or more examples of the present disclosure, the monitoring parameter information includes a target sound type. The sound parameter information includes a first sound type and a sound propagation distance. Performing the Gaussian blur on the first picture to obtain the ideographic graph representing the first virtual character includes: based on the target sound type and/or the first sound type, performing the Gaussian blur on the first picture to obtain the ideographic graph representing the first virtual character, the blur parameter of the ideographic graph is determined according to the target sound type and/or the first sound type, and the blur parameter includes the size and/or clarity of the ideographic graph; or based on the sound propagation distance, performing the Gaussian blur on the first picture to obtain the ideographic graph representing the first virtual character, the blur parameter of the ideographic graph is determined according to the sound propagation distance, and the blur parameter includes the size and/or clarity of the ideographic graph.

In one or more examples of the present disclosure, displaying the ideographic graph representing the first virtual character at the mapping position includes: determining the display duration of the ideographic graph representing the first virtual character according to the monitoring parameter information and/or the sound parameter information; and displaying the ideographic graph at the mapping position according to the display duration.

In one or more examples of the present disclosure, the method further includes: in response to the change of the first position, updating the mapping position in real time, thereby updating the display position of the ideographic graph on the graphical user interface, so that the ideographic graph reflects the position change of the first virtual character in real time.

In one or more examples of the present disclosure, the sound parameter information includes sound propagation distance. The method further includes generating a tracking control according to the sound monitoring result, the tracking control including the sound propagation distance; and displaying the tracking control for representing the first virtual character at the mapping position.

The specific details of the display control device 1500 in the game above have been described in detail in the display control method in the corresponding game, so they are not repeated here.

It should be noted that although several modules or units of the display control device 1500 in the game are mentioned in the above detailed description, this division is not mandatory. In fact, according to the embodiment of the present disclosure, the features and functions of two or more modules or units described above can be embodied in one module or unit. Conversely, the features and functions of one module or unit described above can be embodied by further dividing into multiple modules or units.

In addition, in one or more examples of the present disclosure, an electronic device capable of implementing the above method is also provided.

The electronic device 1600 according to this embodiment of the present disclosure is described below with reference to FIG. 16. The electronic device 1600 shown in FIG. 16 is only an example and should not impose any restrictions on the functions and scope of use of the embodiment of the present disclosure.

As shown in FIG. 16, the electronic device 1600 is presented in the form of a general computing device. The components of the electronic device 1600 may include but are not limited to: the at least one processing unit 1610, the at least one storage unit 1620, the bus 1630 connecting different system components (including the storage unit 1620 and the processing unit 1610), and the display unit 1640.

The storage unit stores a program code, which can be executed by the processing unit 1610, so that the processing unit 1610 executes the steps according to various examples of the present disclosure described in the above “Examples of Method” section of this specification, for example:

A graphical user interface is provided through a target terminal device. The content displayed by the graphical user interface at least includes entire or partial game scene of the game. The game scene includes a target virtual character controlled by the target terminal device and a first virtual character controlled by other terminal devices. The method includes:
acquiring the monitoring parameter information of the target virtual character and acquiring the sound parameter information of the first virtual character;
calculating based on the monitoring parameter information and the sound parameter information and obtaining a sound monitoring result, the sound monitoring result including whether the sound of the first virtual character can be monitored;
when the sound of the first virtual character can be monitored, determining the corresponding mapping position on the graphical user interface according to the first position of the first virtual character in the game scene;
displaying the ideographic graph representing the first virtual character at the mapping position.

In some examples, the monitoring parameter information includes a target sound type, a monitoring capability level and noise level information;
acquiring the monitoring parameter information of the target virtual character includes:
acquiring the target sound type of the target virtual character;
acquiring the monitoring capability level of the target virtual character;
acquiring the noise level information of the target virtual character.

In some examples, acquiring the monitoring capability level of the target virtual character includes:
acquiring the target attribute information of the target virtual character, and acquiring the mapping relationship between the target attribute information and the monitoring capability level;
querying the monitoring capability level corresponding to the target attribute information in the mapping relationship.

In some examples, acquiring the noise level information of the target virtual character includes:
acquiring the target sound intensity emitted by the target virtual character according to the target sound type, and acquiring the monitoring noise threshold of the target virtual character according to the target sound type;
comparing the target sound intensity and the monitoring noise threshold and obtaining a comparison result, and determining the noise level information of the target virtual character according to the comparison result.

In some examples, the method further includes:
when the target virtual character does not make a sound, determining the noise level information of the target virtual character.

In some examples, the sound parameter information includes a first sound type and a sound propagation distance. The first sound type includes at least one of the following types: a first movement type, a first attack type, and a first preparation for attack type.

In some examples, the monitoring parameter information includes: a monitoring capability level and noise level information. The sound parameter information includes a first sound type and a sound propagation distance,
calculating based on the monitoring parameter information and the sound parameter information and obtaining the sound monitoring result includes:
when the noise level information indicates that the first virtual character is monitored, obtaining a first sound intensity according to the first sound type;
acquiring the monitoring coefficient of the target virtual character according to the monitoring capability level, and calculating based on the first sound intensity and the monitoring coefficient to obtain the monitoring capability information;
comparing the monitoring capability information and the sound propagation distance to obtain the sound monitoring result.

In some examples, the ideographic graph is a model outline of the first virtual character.

In some examples, the ideographic graph is a graph obtained by blurring the model outline of the first virtual character.

In some examples, determining the corresponding mapping position on the graphical user interface according to the first position of the first virtual character in the game scene includes:
determining the mapping position corresponding to the first position on the graphical user interface according to the first position of the first virtual character in the game scene and the camera parameters of the virtual camera; where the virtual camera is configured to capture entire or partial game scene of the game to obtain the game scene picture displayed on the graphical user interface.

In some examples, displaying the ideographic graph representing the first virtual character at the mapping position includes:
determining the non-visible area of the first virtual character for the target virtual character according to the camera parameters, and displaying the ideographic graph representing the non-visible area of the first virtual character at the mapping position; where the non-visible area includes entire or partial area of the first virtual character, and the part of the area of the first virtual character includes one or more virtual body parts of the first virtual character.

In some examples, the method further includes:
determining that the entire area of the first virtual character is visible to the target virtual character according to the camera parameters, and not displaying the ideographic graph configured to represent the first virtual character.

In some examples, displaying the ideographic graph configured to represent the first virtual character at the mapping position includes:
blurring the first virtual character to obtain the ideographic graph representing the first virtual character, and displaying the ideographic graph at the mapping position.

In some examples, blurring the first virtual character to obtain the ideographic graph representing the first virtual character includes:
performing an image matting process on the first virtual character to obtain the first picture;
performing Gaussian blur on the first picture to obtain the ideographic graph representing the first virtual character.

In some examples, the monitoring parameter information includes a target sound type. The sound parameter information includes a first sound type and a sound propagation distance.

Performing the Gaussian blur on the first picture to obtain the ideographic graph representing the first virtual character includes:
based on the target sound type and/or the first sound type, performing the Gaussian blur on the first picture to obtain the ideographic graph representing the first virtual character, the blur parameter of the ideographic graph is determined according to the target sound type and/or the first sound type, and the blur parameter includes the size and/or clarity of the ideographic graph; or
based on the sound propagation distance, performing the Gaussian blur on the first picture to obtain the ideographic graph representing the first virtual character, the blur parameter of the ideographic graph is determined according to the sound propagation distance, and the blur parameter includes the size and/or clarity of the ideographic graph.

In some examples, displaying the ideographic graph representing the first virtual character at the mapping position includes:
determining the display duration of the ideographic graph representing the first virtual character according to the monitoring parameter information and/or the sound parameter information;
displaying the ideographic graph at the mapping position according to the display duration.

In some examples, the method further includes:
in response to the change of the first position, updating the mapping position in real time, thereby updating the display position of the ideographic graph on the graphical user interface, so that the ideographic graph reflects the position change of the first virtual character in real time.

In some examples, the sound parameter information includes a sound propagation distance,
the method further includes:
generating a tracking control according to the sound monitoring result, the tracking control includes the sound propagation distance;
displaying the tracking control for representing the first virtual character at the mapping position.

Through the above method, the monitoring parameter information of the target virtual character and the sound parameter information of the first virtual character are obtained as the data basis for rendering the ideographic graph, which enriches the data dimensions for rendering the ideographic graph, improves the dynamic degree and real-time performance of the ideographic graph rendering, improves the accuracy of the sound source positioning, and provides more realistic auditory and visual effects. Furthermore, the ideographic graph of the first virtual character is rendered and displayed according to the sound monitoring result, the first virtual character is displayed in a fuzzy manner, accurately depicting the position of the first virtual character, while striking a balance with over-exposing the position of the first virtual character, and achieving the directional effect of real-time tracking and marking the first virtual character. When the ideographic graphs of multiple first virtual characters are rendered and displayed simultaneously, the problem of being unable to track multiple sound sources in the same direction can be further solved, which is convenient for players to grasp the number of first virtual characters and optimize the game experience of players.

The storage unit 1620 may include a readable medium in the form of a volatile storage unit, such as a random-access storage unit (RAM) 1621 and/or a cache storage unit 1622, and may further include a read-only storage unit (ROM) 1623.

The storage unit 1620 may also include a program/utility 1624 having a set (at least one) of program modules 1625, such program modules 1625 include but are not limited to: an operating system, one or more application programs, other program modules, and program data, each of which or a combination thereof may include the implementation of a network environment.

The bus 1630 may represent one or more of several types of bus structures, including a storage unit bus or a storage unit controller, a peripheral bus, a graphics acceleration port, a processing unit, or a local bus using any of a variety of bus structures.

The electronic device 1600 may also communicate with one or more external devices 1800 (e.g., keyboards, pointing devices, Bluetooth devices, etc.), one or more devices that enable a user to interact with the electronic device 1600, and/or any device that enables the electronic device 1600 to communicate with one or more other computing devices (e.g., routers, modems, etc.). Such communication may be performed through an input/output (I/O) interface 1650. In addition, the electronic device 1600 may also communicate with one or more networks (e.g., a local area network (LAN), a wide area network (WAN), and/or a public network, such as the Internet) through a network adapter 1660. As shown, the network adapter 1660 communicates with other modules of the electronic device 1600 through a bus 1630. It should be understood that, although not shown in the figure, other hardware and/or software modules may be used in conjunction with the electronic device 1600, including but not limited to: microcode, device drivers, redundant processing units, external disk drive arrays, RAID systems, tape drives, and data backup storage systems, etc.

Through the description of the above embodiments, it is easy for those skilled in the art to understand that the example embodiments described here can be implemented by software or by combining software with necessary hardware. Therefore, the technical solution according to the embodiment of the present disclosure can be embodied in the form of a software product, which can be stored in a non-volatile storage medium (which can be a CD-ROM, a USB flash drive, a mobile hard disk, etc.) or on a network, and includes several instructions to enable a computing device (which can be a personal computer, a server, a terminal device, or a network device, etc.) to execute the method according to the embodiment of the present disclosure.

In the example of the present disclosure, a non-transitory computer-readable storage medium is also provided, on which a program product capable of implementing the above method of the present specification is stored. In some possible embodiments, various aspects of the present disclosure may also be implemented in the form of a program product, which includes a program code. When the program product is run on a terminal device, the program code is used to enable the terminal device to execute the steps according to various examples of the present disclosure described in the above “Examples of Method” section of this specification, for example:
a graphical user interface is provided through a target terminal device, the content displayed by the graphical user interface at least includes entire or partial game scene of the game, and the game scene includes a target virtual character controlled by the target terminal device and a first virtual character controlled by other terminal devices. The method includes:
acquiring the monitoring parameter information of the target virtual character and acquiring the sound parameter information of the first virtual character;
calculating based on the monitoring parameter information and the sound parameter information and obtaining a sound monitoring result, the sound monitoring result including whether the sound of the first virtual character can be monitored;
when the sound of the first virtual character can be monitored, determining the corresponding mapping position on the graphical user interface according to the first position of the first virtual character in the game scene;
displaying the ideographic graph representing the first virtual character at the mapping position.

In some examples, the monitoring parameter information includes a target sound type, a monitoring capability level and noise level information;
acquiring the monitoring parameter information of the target virtual character includes:
acquiring the target sound type of the target virtual character;
acquiring the monitoring capability level of the target virtual character; and
acquiring the noise level information of the target virtual character.

In some examples, acquiring the monitoring capability level of the target virtual character includes:
acquiring the target attribute information of the target virtual character, and acquiring the mapping relationship between the target attribute information and the monitoring capability level;
querying the monitoring capability level corresponding to the target attribute information in the mapping relationship.

In some examples, acquiring the noise level information of the target virtual character includes:
acquiring the target sound intensity emitted by the target virtual character according to the target sound type, and acquiring the monitoring noise threshold of the target virtual character according to the target sound type;
comparing the target sound intensity and the monitoring noise threshold to obtain a comparison result, and determining the noise level information of the target virtual character according to the comparison result.

In some examples, the method further includes:
when the target virtual character does not make a sound, determining the noise level information of the target virtual character.

In some examples, the sound parameter information includes a first sound type and a sound propagation distance, and the first sound type includes at least one of the following types: a first movement type, a first attack type, and a first preparation for attack type.

In some examples, the monitoring parameter information includes a monitoring capability level and noise level information; the sound parameter information includes a first sound type and a sound propagation distance,
obtaining the sound monitoring result by calculating based on the monitoring parameter information and the sound parameter information includes:
when the noise level information indicates that the first virtual character is monitored, obtaining a first sound intensity according to the first sound type;
acquire the monitoring coefficient of the target virtual character according to the monitoring capability level, and calculating based on the first sound intensity and the monitoring coefficient to obtain the monitoring capability information;
comparing the monitoring capability information and the sound propagation distance to obtain the sound monitoring result.

In some examples, the ideographic graph is a model outline of the first virtual character.

In some examples, the ideographic graph is a graph obtained by blurring the model outline of the first virtual character.

In some examples, determining the corresponding mapping position on the graphical user interface according to the first position of the first virtual character in the game scene includes:
determining the mapping position corresponding to the first position on the graphical user interface according to the first position of the first virtual character in the game scene and the camera parameters of the virtual camera; where the virtual camera is configured to capture entire or partial game scene of the game to obtain the game scene picture displayed on the graphical user interface.

In some examples, displaying the ideographic graph representing the first virtual character at the mapping position includes:
determining the non-visible area of the first virtual character for the target virtual character according to the camera parameters, and displaying the ideographic graph representing the non-visible area of the first virtual character at the mapping position; where the non-visible area includes entire or partial area of the first virtual character, and the part of the area of the first virtual character includes one or more virtual body parts of the first virtual character.

In some examples, the method further includes:
determining that the entire area of the first virtual character is visible to the target virtual character according to the camera parameters, and not displaying the ideographic graph representing the first virtual character.

In some examples, displaying the ideographic graph representing the first virtual character at the mapping position includes:
blurring the first virtual character to obtain the ideographic graph representing the first virtual character, and displaying the ideographic graph at the mapping position.

In some examples, blurring the first virtual character to obtain the ideographic graph representing the first virtual character includes:
performing an image matting process on the first virtual character to obtain a first picture;
performing Gaussian blur on the first picture to obtain the ideographic graph representing the first virtual character.

In some examples, the monitoring parameter information includes a target sound type; the sound parameter information includes a first sound type and a sound propagation distance;

Performing the Gaussian blur on the first picture to obtain the ideographic graph representing the first virtual character includes:
based on the target sound type and/or the first sound type, performing the Gaussian blur on the first picture to obtain the ideographic graph representing the first virtual character, the blur parameter of the ideographic graph is determined according to the target sound type and/or the first sound type, and the blur parameter includes the size and/or clarity of the ideographic graph; or
based on the sound propagation distance, performing the Gaussian blur on the first picture to obtain the ideographic graph representing the first virtual character, the blur parameter of the ideographic graph is determined according to the sound propagation distance, and the blur parameter includes the size and/or clarity of the ideographic graph.

In some examples, displaying the ideographic graph for representing the first virtual character at the mapping position includes:
determining the display duration of the ideographic graph for representing the first virtual character according to the monitoring parameter information and/or the sound parameter information;
displaying the ideographic graph at the mapping position according to the display duration.

In some examples, the method further includes:
in response to the change of the first position, updating the mapping position in real time, thereby updating the display position of the ideographic graph on the graphical user interface, so that the ideographic graph reflects the position change of the first virtual character in real time.

In some examples, the sound parameter information includes a sound propagation distance,
the method further includes:
generating a tracking control according to the sound monitoring result, the tracking control includes the sound propagation distance;
displaying the tracking control for representing the first virtual character at the mapping position.

Through the above method, the monitoring parameter information of the target virtual character and the sound parameter information of the first virtual character are acquired as the data basis for rendering the ideographic graph, which enriches the data dimensions for rendering the ideographic graph, improves the dynamic degree and real-time performance of the ideographic graph rendering, improves the accuracy of sound source positioning, and provides more realistic auditory and visual effects. Furthermore, according to the sound monitoring result, the ideographic graph of the first virtual character is rendered and displayed, and the first virtual character is displayed in a fuzzy manner, accurately depicting the position of the first virtual character, while striking a balance with over-exposing the position of the first virtual character, and achieving the directional effect of real-time tracking and marking the first virtual character. When the ideographic graphs of multiple first virtual characters are rendered and displayed at the same time, the problem of being unable to track multiple sound sources in the same direction can be further solved, which is convenient for players to grasp the number of first virtual characters and optimize the game experience of players.

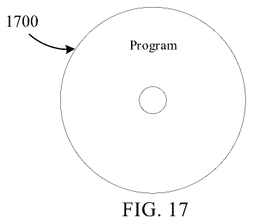

Referring to FIG. 17, a program product 1700 for implementing the above method according to an embodiment of the present disclosure is described, which can adopt a portable compact disk read-only memory (CD-ROM) and include program code, and can be run on a terminal device, such as a personal computer. However, the program product of the present disclosure is not limited thereto. In this document, a readable storage medium can be any tangible medium containing or storing a program, which can be used by or in combination with an instruction execution system, an apparatus or a device.

The program product can adopt any combination of one or more readable media. The readable medium can be a readable signal medium or a readable storage medium. The readable storage medium may be, for example, but not limited to, an electrical, magnetic, optical, electromagnetic, infrared, or semiconductor system, device or device, or any combination thereof. More specific examples of readable storage media (a non-exhaustive list) include: an electrical connection with one or more conductors, a portable disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

Computer-readable signal media may include a data signal propagated in baseband or as part of a carrier wave, carrying readable program code. Such propagated data signals may take a variety of forms, including but not limited to electromagnetic signals, optical signals, or any suitable combination thereof. The readable signal medium may also be any readable medium other than a readable storage medium, which may send, propagate, or transmit a program for use by or in conjunction with an instruction execution system, device, or component.

The program code contained on the readable medium may be transmitted using any appropriate medium, including but not limited to wireless, wired, optical cable, RF, etc., or any suitable combination thereof.

Program code for performing the operations of the present disclosure may be written in any combination of one or more programming languages, including object-oriented programming languages such as Java, C++, etc., and conventional procedural programming languages such as “C” or similar programming languages. The program code may be executed entirely on the user computing device, partially on the user device, as a separate software package, partially on the user computing device and partially on a remote computing device, or entirely on a remote computing device or server. In the case of a remote computing device, the remote computing device may be connected to the user computing device through any type of network, including a local area network (LAN) or a wide area network (WAN), or may be connected to an external computing device (e.g., using an Internet service provider to connect through the Internet).

Other embodiments of the present disclosure will be readily apparent to those skilled in the art after considering the specification and practicing the disclosure disclosed herein. The present application is intended to cover any variations, uses, or adaptations of the present disclosure that follow the general principles of the present disclosure and include common knowledge or customary technical means in the art that are not disclosed in the present disclosure. It is intended that the specification and embodiments be considered as example only. with a true scope and spirit of the disclosure being indicated by the following claims.

1. A display control method in a game, comprising:
providing a graphical user interface through a target terminal device, wherein content displayed on the graphical user interface comprises a game scene of the game, and the game scene comprises a target virtual character controlled by the target terminal device and a first virtual character controlled by another terminal device;
acquiring monitoring parameter of the target virtual character, and acquiring sound parameter of the first virtual character;
obtaining a sound monitoring result by calculating based on the monitoring parameter and the sound parameter, wherein the sound monitoring result comprises whether a sound of the first virtual character can be monitored;
in response to determining that the sound of the first virtual character can be monitored, determining a mapping position corresponding to a first position of the first virtual character on the graphical user interface according to the first position of the first virtual character in the game scene; and
displaying an ideographic graph representing the first virtual character at the mapping position.

2. The display control method in the game according to claim 1, wherein the monitoring parameter comprises a target sound type, a monitoring capability level and noise level; and
wherein acquiring the monitoring parameter of the target virtual character comprises:
acquiring the target sound type of the target virtual character;
acquiring the monitoring capability level of the target virtual character; and
acquiring the noise level of the target virtual character.

3. The display control method in the game according to claim 2, wherein acquiring the monitoring capability level of the target virtual character comprises:
acquiring target attribute information of the target virtual character, and acquiring a mapping relationship between the target attribute information and the monitoring capability level; and
querying the monitoring capability level corresponding to the target attribute information in the mapping relationship.

4. The display control method in the game according to claim 2, wherein acquiring the noise level of the target virtual character comprises:
acquiring a target sound intensity emitted by the target virtual character according to the target sound type, and acquiring a monitoring noise threshold of the target virtual character according to the target sound type; and
obtaining a comparison result by comparing the target sound intensity and the monitoring noise threshold, and determining the noise level of the target virtual character according to the comparison result.

5. The display control method in the game according to claim 4, further comprising:
in response to determining that the target virtual character does not emit a sound, determining the noise level of the target virtual character.

6. The display control method in the game according to claim 1, wherein the sound parameter comprises a first sound type and a sound propagation distance, and the first sound type comprises at least one of the following: a first movement type, a first attack type, or a first preparation for attack type.

7. The display control method in the game according to claim 1, wherein the monitoring parameter comprises a monitoring capability level and a noise level; the sound parameter comprises a first sound type and a sound propagation distance, and
obtaining the sound monitoring result by calculating based on the monitoring parameter and the sound parameter comprises:
in response to determining that the noise level indicates that the first virtual character is monitored, obtaining a first sound intensity according to the first sound type;
obtaining a monitoring coefficient of the target virtual character according to the monitoring capability level, and obtaining the monitoring capability information by calculating based on the first sound intensity and the monitoring coefficient; and
obtaining the sound monitoring result by comparing the monitoring capability information and the sound propagation distance.

8. The display control method in the game according to claim 1, wherein the ideographic graph is a model outline of the first virtual character.

9. The display control method in the game according to claim 1, wherein the ideographic graph is a graph obtained by blurring a model outline of the first virtual character.

10. The display control method in the game according to claim 1, wherein determining the mapping position on the graphical user interface corresponding to the first position of the first virtual character in the game scene according to the first position of the first virtual character in the game scene comprises:
determining the mapping position corresponding to the first position on the graphical user interface according to the first position of the first virtual character in the game scene and a camera parameter of a virtual camera; wherein the virtual camera is configured to capture the game scene of the game to obtain a game scene picture displayed on the graphical user interface.

11. The display control method in the game according to claim 10, wherein displaying the ideographic graph representing the first virtual character at the mapping position comprises:
determining a non-visible area of the first virtual character for the target virtual character according to the camera parameter, and displaying the ideographic graph representing the non-visible area of the first virtual character at the mapping position; wherein the non-visible area comprises entire or partial area of the first virtual character, and the partial area of the first virtual character comprises one or more virtual body parts of the first virtual character.

12. The display control method in the game according to claim 10, further comprising:
determining that the entire area of the first virtual character is visible to the target virtual character according to the camera parameter, and not displaying the ideographic graph configured to represent the first virtual character.

13. The display control method in the game according to claim 1, wherein displaying the ideographic graph configured to represent the first virtual character at the mapping position comprises:
obtaining the ideographic graph representing the first virtual character by blurring the first virtual character, and displaying the ideographic graph at the mapping position.

14. The display control method in the game according to claim 13, wherein obtaining the ideographic graph representing the first virtual character by blurring the first virtual character comprises:
obtaining a first picture by performing an image matting process on the first virtual character; and
obtaining the ideographic graph representing the first virtual character by performing a Gaussian blur on the first picture.

15. The display control method in the game according to claim 14, wherein the monitoring parameter comprises a target sound type; the sound parameter comprises a first sound type and a sound propagation distance;
obtaining the ideographic graph representing the first virtual character by performing the Gaussian blur of the first picture comprises:
based on at least one of the target sound type or the first sound type, obtaining the ideographic graph representing the first virtual character by performing the Gaussian blur on the first picture, wherein a blur parameter of the ideographic graph is determined according to at least one of the target sound type or the first sound type, and the blur parameter comprises at least one of a size or a clarity of the ideographic graph; or
based on the sound propagation distance, obtaining the ideographic graph representing the first virtual character by performing the Gaussian blur on the first picture, wherein a blur parameter of the ideographic graph is determined according to the sound propagation distance, and the blur parameter comprises at least one of a size or a clarity of the ideographic graph.

16. The display control method in the game according to claim 1, wherein displaying the ideographic graph configured to represent the first virtual character at the mapping position comprises:
determining a display duration of the ideographic graph configured to represent the first virtual character according to at least one of the monitoring parameter or the sound parameter; and
displaying the ideographic graph at the mapping position according to the display duration.

17. The display control method in the game according to claim 1, further comprising:
in response to a change of the first position, updating the mapping position in real time, and updating a display position of the ideographic graph on the graphical user interface, wherein the ideographic graph reflects position change of the first virtual character in real time.

18. The display control method in the game according to claim 1, wherein the sound parameter comprises a sound propagation distance,
the method further comprises:
generating a tracking control according to the sound monitoring result, the tracking control comprising the sound propagation distance; and
displaying the tracking control configured to represent the first virtual character at the mapping position.

19. (canceled)

20. A non-transitory computer-readable storage medium, with a computer program stored thereon, wherein the computer program implements the following steps when executed by a processor;
providing a graphical user interface through a target terminal device, wherein content displayed by the graphical user interface at least comprises entire or partial game scene of the game, and the game scene comprises a target virtual character controlled by the target terminal device and a first virtual character controlled by another terminal device;
acquiring monitoring parameter of the target virtual character, and acquiring sound parameter of the first virtual character;
obtaining a sound monitoring result by calculating based on the monitoring parameter and the sound parameter, wherein the sound monitoring result comprises whether a sound of the first virtual character can be monitored;
in response to determining that the sound of the first virtual character can be monitored. determining a mapping position corresponding to a first position of the first virtual character in the game scene on the graphical user interface according to the first position of the first virtual character in the game scene; and
displaying an ideographic graph representing the first virtual character at the mapping position.

21. An electronic device, comprising:
a processor;
a memory for storing executable instructions of the processor;
wherein by executing the executable instructions, the processor is configured to:
provide a graphical user interface through a target terminal device, wherein content displayed on the graphical user interface comprises a game scene of the game, and the game scene comprises a target virtual character controlled by the target terminal device and a first virtual character controlled by another terminal device;
acquire monitoring parameter of the target virtual character, and acquire sound parameter of the first virtual character;
obtain a sound monitoring result by calculating based on the monitoring parameter and the sound parameter, the sound monitoring result comprises whether a sound of the first virtual character can be monitored;
in response to determining that the sound of the first virtual character can be monitored. determine a mapping position corresponding to a first position of the first virtual character in the game scene on the graphical user interface according to the first position of the first virtual character in the game scene; and
display an ideographic graph representing the first virtual character at the mapping position.
